(19) United States
(12) Patent Application Publication
(10) Pub. No.: US 2024/0320224 A1
(43) Pub. Date: Sep. 26, 2024

(54) Logical Access for Previewing Expanded View Datasets

(71) Applicant: Ab Initio Technology LLC, Lexington, MA (US)

(72) Inventors: Robert Parks, Weston, MA (US); Jonah Egenolf, Winchester, MA (US); Ian Schechter, Sharon, MA (US)

(21) Appl. No.: 18/492,904

(22) Filed: Oct. 24, 2023

Related U.S. Application Data
(60) Provisional application No. 63/491,921, filed on Mar. 23, 2023.

(51) Int. Cl. G06F 16/2455; G06F 16/2453; G06F 16/2457

(52) U.S. Cl. CPC G06F 16/24568; G06F 16/24542; G06F 16/2457

(57) ABSTRACT

A method implemented by a data processing system for: enabling a user to preview attributes of fields of an expanded view of a base dataset and to specify one or more of the fields to use in downstream data processing and generating a dataset that includes the one or more of the fields from the preview specified to be used in the downstream data processing, with the generated dataset having increased efficiency with respect to speed and data memory, relative to an efficiency of generating a dataset including all the fields of the expanded view when only the specified one or more of the fields are used in the downstream data processing.

### CLAIM OF PRIORITY

This application claims priority under 35 U.S.C. § 119(e) to U.S. Patent Application Ser. No. 63/491,921, filed on Mar. 23, 2023, the entire contents of which are hereby incorporated by reference.

### BACKGROUND

This disclosure relates to techniques for customizing views into large, complex databases.

Modern data processing systems manage vast amounts of data within an enterprise. A large institution, for example, may have millions of datasets. These datasets can support multiple aspects of the operation of the enterprise. Complex data processing systems typically process data in multiple stages, with the results produced by one stage being fed into the next stage. The overall flow of information through such systems may be described in terms of a directed dataflow graph, with nodes or vertices in the graph representing components (either data files or processes), and the links or “edges” in the graph indicating flows of data between the components. A system for executing such graph-based computations is described in U.S. Pat. No. 5,966,072, titled “Executing Computations Expressed as Graphs,” incorporated herein by reference.

Graphs also can be used to invoke computations directly. Graphs made in accordance with this system provide methods for getting information into and out of individual processes represented by graph components, for moving information between the processes, and for defining a running order for the processes. Systems that invoke these graphs include algorithms that choose inter-process communication methods and algorithms that schedule process execution, and also provide for monitoring of the execution of the graph.

To support a wide range of functions, a data processing system may execute applications, whether to implement routine processes or to extract insights from the datasets. The applications may be programmed to access the data stores to read and write data.

### SUMMARY

In general, in a first aspect, a method implemented by a data processing system includes: enabling a user to preview attributes of fields of an expanded view of a base dataset and to specify one or more of the fields to use in downstream data processing and generating a dataset that includes the one or more of the fields from the preview specified to be used in the downstream data processing, with the generated dataset having increased efficiency with respect to speed and data memory, relative to an efficiency of generating a dataset including all the fields of the expanded view when only the specified one or more of the fields are used in the downstream data processing, including: receiving an identification of a base dataset, based on the identification, receiving a definition of an expanded view dataset, wherein the definition of the expanded view dataset specifies other datasets or fields of other datasets related to the base dataset, based on the definition of the expanded view dataset, outputting a preview of attributes of fields of the expanded view dataset, wherein the preview is generated from a subset of data in the other datasets or in the fields of the other datasets related to the base dataset, receiving input that specifies one or more of the fields in the preview to be available for data processing, and based on the input, generating an available dataset that includes data in the base dataset and data in the one or more of the fields specified.

In a second aspect combinable with the first aspect, the method includes providing the preview of the attributes of the expanded view dataset, with the expanded view dataset, when generated, including data from the base dataset and the other datasets related to the base dataset.

In a third aspect combinable with the first or second aspects, the definition of the expanded view dataset specifies a set of data processing operations performed to generate the expanded view dataset that includes the data from the base dataset and the other datasets related to the base dataset, and wherein the preview is generated from applying the set of data processing operations specified by the definition of the expanded view dataset to only a subset of the data in the base dataset and the other datasets related to the base dataset.

In a fourth aspect combinable with any of the first through third aspects, the method includes responsive to providing the preview, receiving a specification that specifies data processing operations, wherein a data processing operation of the specification is at least partly defined based on user input that identifies an attribute included in the preview as an attribute of that data processing operation.

In a fifth aspect combinable with any of the first through fourth aspects, the method includes based on the data processing operation that is at least partly defined based on the user input that identifies the attribute included in the preview as the attribute of that data processing operation, updating the set of data processing operations of the definition by applying one or more optimization rules to the set of data processing operations, and executing the updated set of data processing operations to generate a dataset that includes only a subset of data that would have been included in the expanded view dataset.

In a sixth aspect combinable with any of the first through fifth aspects, the method includes enabling a user to register a definition of a new dataset with a data catalog, with the definition specifying a selected dataset and other datasets related to the selected data, wherein the definition provides for logical access of the other datasets related to the base dataset without incurring a computational cost of providing the other related datasets.

In a seventh aspect combinable with any of the first through sixth aspects, the method includes accessing a data catalog specifying one or more datasets, and providing a user interface indicating that the one or more datasets are candidates for generating the expanded view dataset.

In an eighth aspect combinable with any of the first through seventh aspects, the method includes receiving, through the user interface, an indication of a particular dataset as the base dataset, and responsive to the indication, automatically generating the definition of the expanded view dataset for the particular, base dataset.

In a ninth aspect combinable with any of the first through eighth aspects, the method includes identifying the particular, base dataset as the base dataset and one or more attributes of the particular, base dataset, determining, from the one or more attributes, a definition of the base dataset, based on the definition of the base dataset, determining, the one or more other datasets that are related to the base dataset, and based on the determined one or more other datasets, generating the definition of the expanded view dataset that specifies the base dataset, the one or more other datasets and one or more relationships among the base dataset and the one or more other datasets.

In a tenth aspect combinable with any of the first through ninth aspects, the method includes storing, in a hardware storage device, the definition of the expanded view dataset, and registering the definition of the expanded view dataset with a data catalog.

In an eleventh aspect combinable with any of the first through tenth aspects, the method includes receiving a request for the expanded view dataset, responsive to the request, providing the expanded view dataset, by: retrieving, from a hardware storage device, the definition of the expanded view dataset, based on the definition of the expanded view dataset, retrieving, from one or more data sources, the base dataset and the one or more other datasets, and based on data in the retrieved datasets, generating the expanded view dataset.

In a twelfth aspect combinable with any of the first through eleventh aspects, the method includes based on the expanded view dataset, determining whether to update the data catalog to specify the definition of the expanded view dataset as a data source, storing, in a hardware storage device, the definition of the expanded view dataset, and registering the definition of the expanded view dataset with the data catalog.

In a thirteenth aspect combinable with any of the first through twelfth aspects, the method includes based on the provided preview of the attributes of the expanded view dataset, determining whether to update the data catalog to specify the definition of the expanded view dataset as a data source.

In a fourteenth aspect combinable with any of the first through thirteenth aspects, generating the available dataset includes using the definition of the expanded view dataset to only access those datasets with the specified one or more fields and including data of those accessed datasets into the available dataset.

In a fifteenth aspect combinable with any of the first through fourteenth aspects, the method includes processing the generated available dataset to obtain a result from processing the data of the available dataset.

In a sixteenth aspect combinable with any of the first through fifteenth aspects, the method includes providing a user permission to access portions of the base dataset in the expanded view dataset, while denying the user access to remaining portions of the base dataset.

In a seventeenth aspect combinable with any of the first through sixteenth aspects, the definition of the expanded view dataset includes a computational graph that specifies a set of data processing operations to generate the expanded view dataset that includes the data from the base dataset and the other datasets related to the base dataset, the set of data processing operations including at least one operation to join the data from the base dataset and data from at least one of the other datasets related to the base dataset.

In an eighteenth aspect combinable with any of the first through seventeenth aspects, the definition of the expanded view dataset provides logical access to data from the base dataset and the other datasets related to the base dataset. The foregoing actions of the method may be combined in any and all combinations.

In a nineteenth aspect combinable with any of the first through eighteenth aspects, the preview is generated at development time.

In general, in a twentieth aspect, a method implemented by a data processing system for: enabling a user to preview attributes of fields of an expanded view of a base dataset and to specify one or more of the fields to use in downstream data processing and generating a dataset that includes the one or more of the fields from the preview specified to be used in the downstream data processing, with the generated dataset having increased efficiency with respect to speed and data memory, relative to an efficiency of generating a dataset including all the fields of the expanded view when only the specified one or more of the fields are used in the downstream data processing, includes receiving an identification of a base dataset, based on the identification, receiving a definition of an expanded view dataset, wherein the definition of the expanded view dataset specifies other datasets or fields of other datasets related to the base dataset, based on the definition of the expanded view dataset, outputting a preview of attributes of fields of the expanded view dataset, wherein the preview is generated from a subset of data in the other datasets or metadata of the other datasets related to the base dataset, receiving input that specifies one or more of the fields in the preview to be available for data processing, and based on the input, generating an available dataset that includes data in the base dataset and data in the one or more of the fields specified.

In general, in a twenty-first aspect, a data processing system includes one or more processing devices and one or more machine-readable hardware storage devices storing instructions that are executable by the one or more processing devices to perform the operations of any of the first through twentieth aspects.

In general, in a twenty-second aspect, one or more machine-readable hardware storage devices store instructions that are executable by one or more processing devices to perform the operations of any of the first through twenty-first aspects.

A system of one or more computers can be configured to perform particular operations or actions by virtue of having software, firmware, hardware, or a combination of them installed on the system that in operation causes or cause the system to perform the actions-including any and all of the foregoing actions in any combination. One or more computer programs can be configured to perform particular operations or actions by virtue of including instructions that, when executed by data processing apparatus, cause the apparatus to perform the actions-including any and all of the foregoing actions in any combination.

One or more of the above aspects may provide one or more of the following advantages.

An expanded view dataset can represent a subset of data contained in a dataset. Definitions of expanded view datasets occupy relatively small amounts of storage space, because the definitions of expanded view dataset only provide logical access to datasets, but do not contain a copy of all the data that the original dataset presents. In particular, when an expanded view dataset is requested, the system generates and stores only a definition of that expanded view dataset. The definition provides the logical access without the physical cost of materializing the expanded view dataset, as described below. The definition allows previewing of fields in the expanded view dataset, without materialization of the entire expanded view dataset. This preview (which can be generated at development or authoring time) allows selection or specification of which fields are required for processing. Then, at a time of actually performing the processing (e.g., runtime), the system uses the definition to only access those datasets with required fields and those accessed datasets are made available for the processing through an available dataset. An available dataset includes the one or more of the fields from the preview specified to be used in the downstream data processing, with the generated available dataset having increased efficiency with respect to speed and data memory, relative to an efficiency of generating a dataset including all the fields of the expanded view when only the specified one or more of the fields are used in the downstream data processing. According to aspects, the expanded view dataset can limit the degree of exposure of underlying datasets to the outside world. A given user may have permission to read the expanded view dataset that has portions of an underlying base dataset, while being denied access to remaining portions of the base dataset. The expanded view dataset can join and simplify multiple datasets into a single virtual dataset. The expanded view dataset can act as an aggregated dataset, where the system aggregates data (sum, average, etc.) presents results as part of the data in the expanded view dataset. The expanded view dataset can hide complexity of data, by transparently partitioning the actual underlying dataset.

The expanded view dataset is the result of executing a set of stored transformation logic, which catalog users can access just as they would access a persistent dataset. Expanded view datasets are efficient when returning multiple axis of data and avoiding data duplication. Expanded view dataset use relations of their underlying base datasets that retain their relationship to their base dataset, by using a primary key of the base dataset and foreign key relationships of the base dataset to find related datasets.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system.

FIG. 2 is a diagram of a system for previewing attributes of an expanded view dataset.

FIGS. 3A-3F are diagrams of the system of FIG. 2 in stages of expanded view definition.

FIGS. 4A-4E each illustrate a diagram showing stages of generating an expanded view dataset.

FIGS. 5, 5A-5C are flow diagrams processes for previewing attributes of an expanded view dataset.

FIG. 6 is a diagram showing details of a computer system, such as a data processing system.

### DETAILED DESCRIPTION

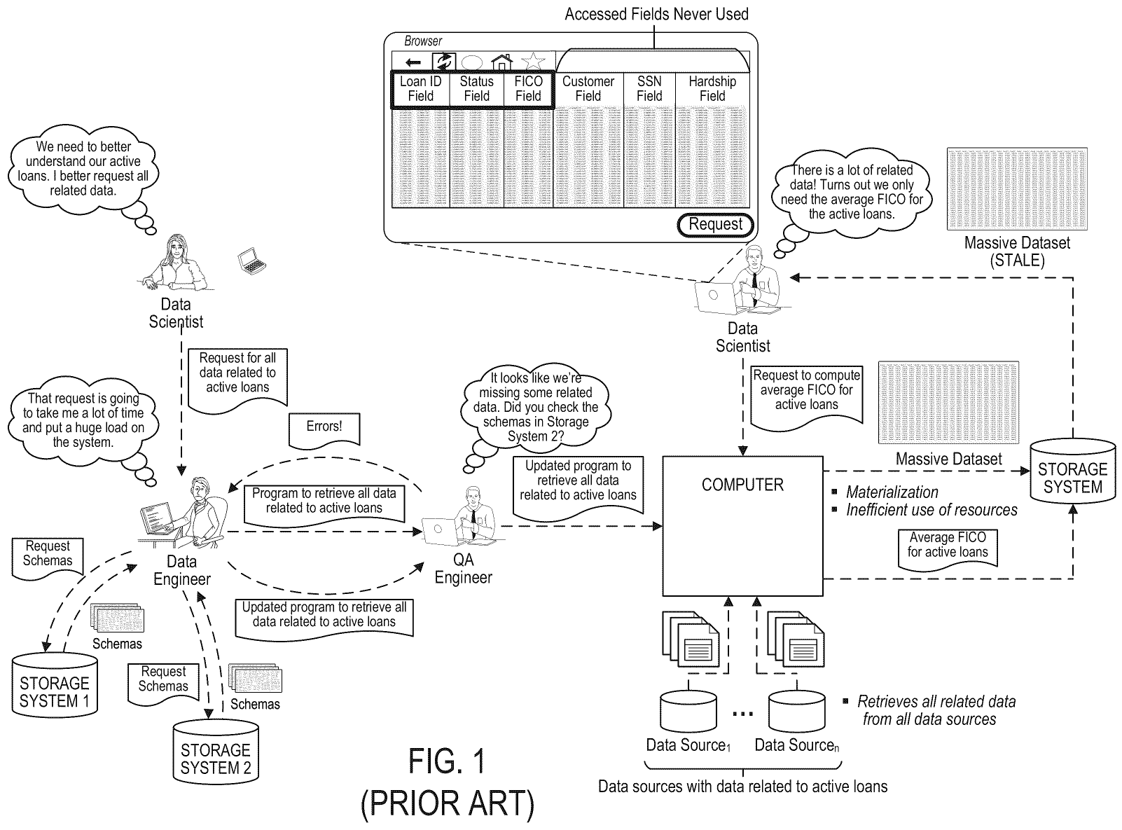

Referring to FIG. 1, a diagram is shown of the complexity of understanding and accessing data when that data is distributed across disparate data sources within an enterprise or a system. Additionally, this diagram shows how current systems are computationally inefficient in bringing together all of the data from disparate data sources that may be required to do a specific calculation or computation. In this example, a data scientist wants to better understand and be able to use all of the data that's available across an enterprise or a system. So, the data scientist sends to a data engineer a request for all data related to—in this example—an active loans dataset.

The data engineer then has to identify all of the data that is related to the active loans dataset. The data engineer does so by requesting schemas from various systems across the enterprise and generating a program to retrieve all that data related to active loans. Once the data engineer generates the program, the program is sent to the quality engineer who identifies some errors in the program. These errors are sent back to the data engineer and perhaps one month or two months later the data engineer has an updated program to retrieve all the data that's related to active loans. But even this updated program may be missing some data, or it may still have some errors. The fact is that the data engineer may not be able to identify all of the data sources and datasets that are related to active data.

The quality engineer will transmit this updated program to a computer that will run it against various data sources. The computer program will generate a massive dataset which—and at the very instance that it is created—is already stale. This is because the dataset is being generated in advance of any program or data operation actually calling or using that dataset. In this example, it may be five days later or five months later that a data scientist is reviewing the massive dataset to see what data is available in the system. When the data scientist is reviewing this massive dataset, it is now stale, because it is now five days old.

In this example, a data scientist may request to calculate the average FICO for active loans. The data scientist may send this request to the computer, which will implement logic to execute the request. This process is incredibly inefficient because it results in the materialization of all the data that is related to active loans, when in fact, only a portion of that data is actually needed to compute the request of the data scientist. In this example, only the loan ID field, the status field, and the FICO field are needed to complete the request of the data scientist. But, in generating a dataset for the data scientist to see what data was even available, the computer materialized all of the data that is related to active loans and this materialization is not only costly because all of the materialized data has to be stored, but is also computationally inefficient because the computer has to extend resources to join together all of this data into a dataset for review by the data scientist.

Additionally, this dataset is stale—as previously discussed. So, a need exists for a system that can efficiently generate a dataset with only the data that is actually needed for a computation and can pull that data on demand in real-time in response to a request—thus ensuring that the data is not stale—while at the same time, allowing logical access to that data—to enable understanding and previewing of what data is available—without the actual materialization of that data.

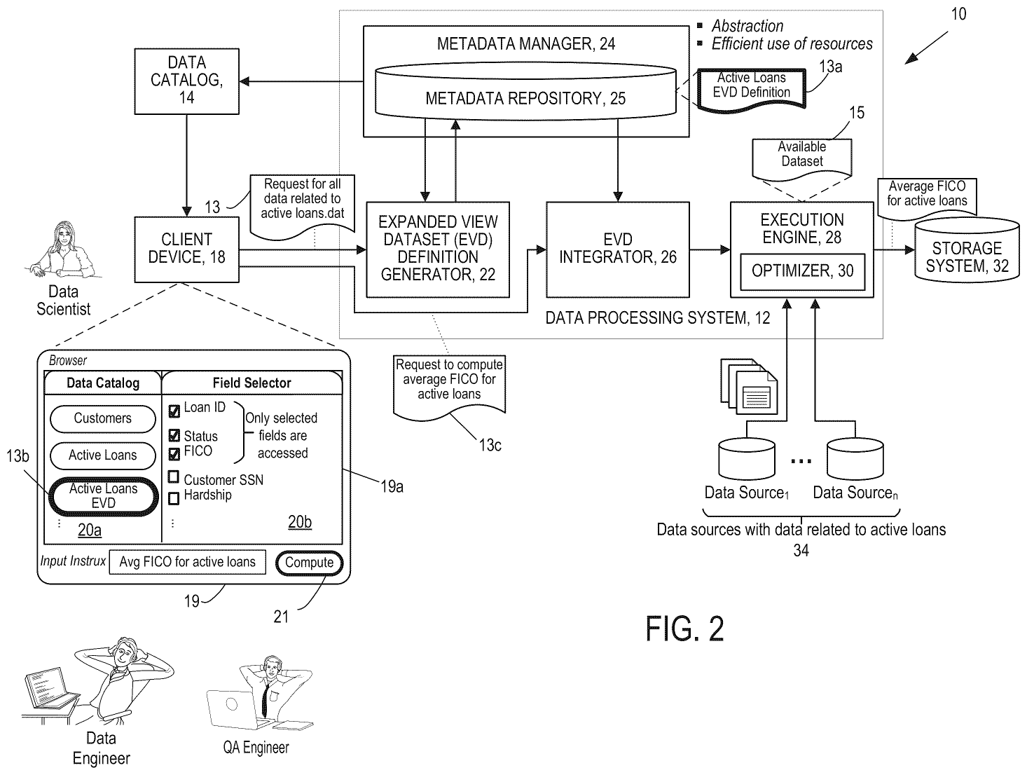

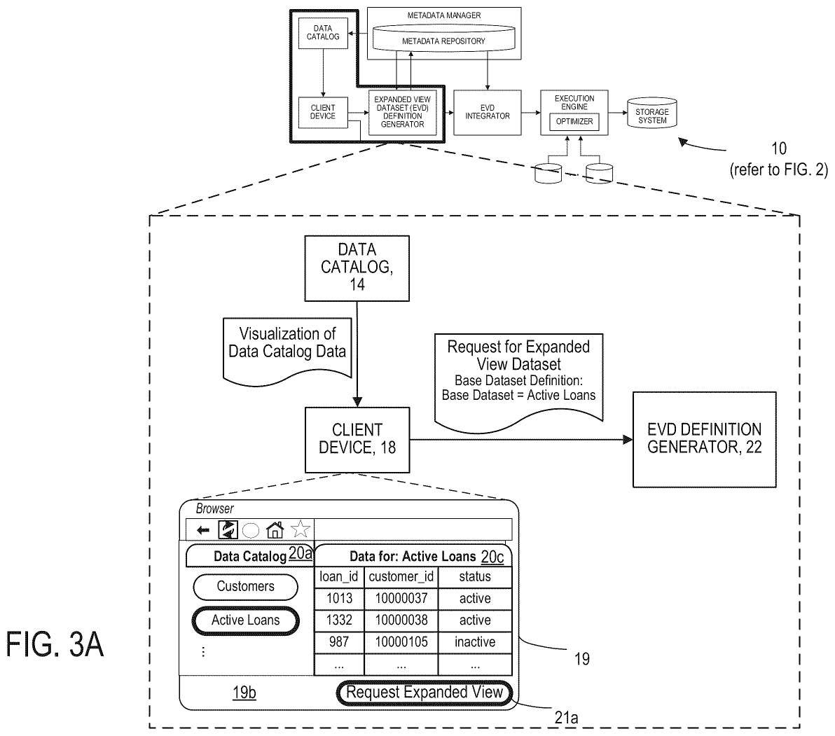

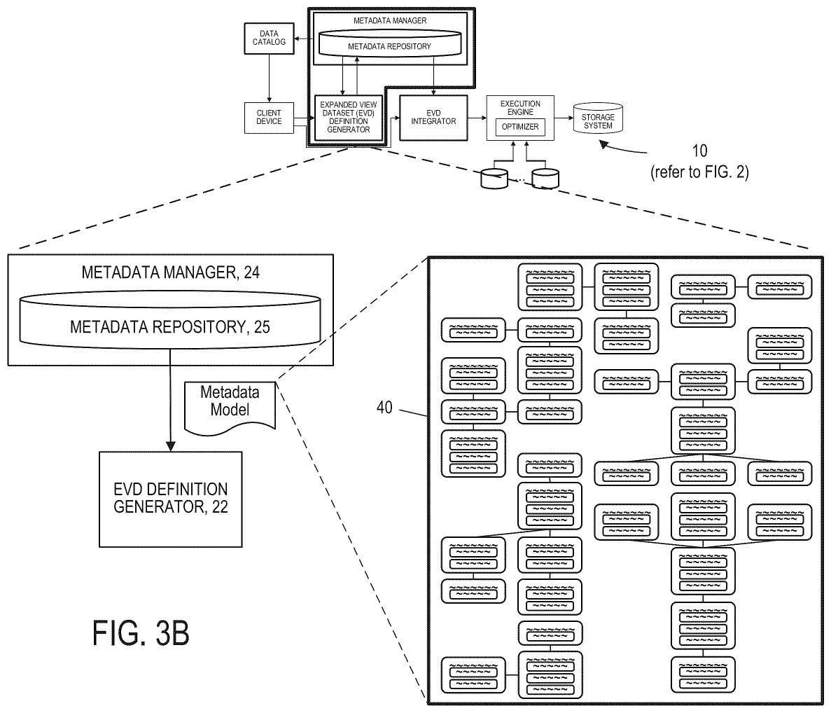

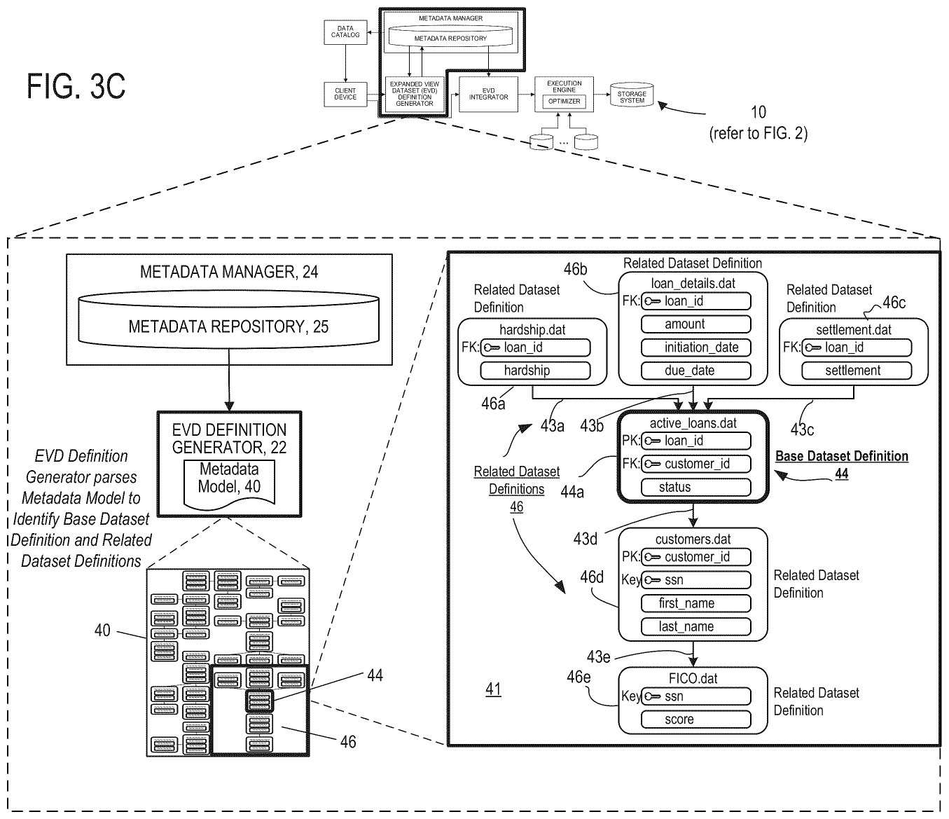

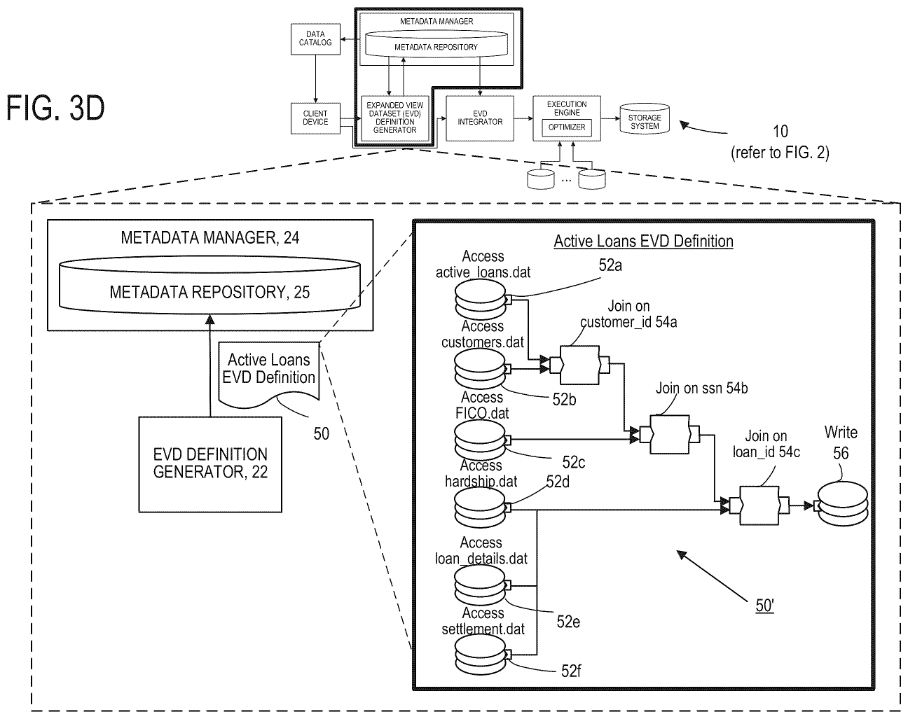

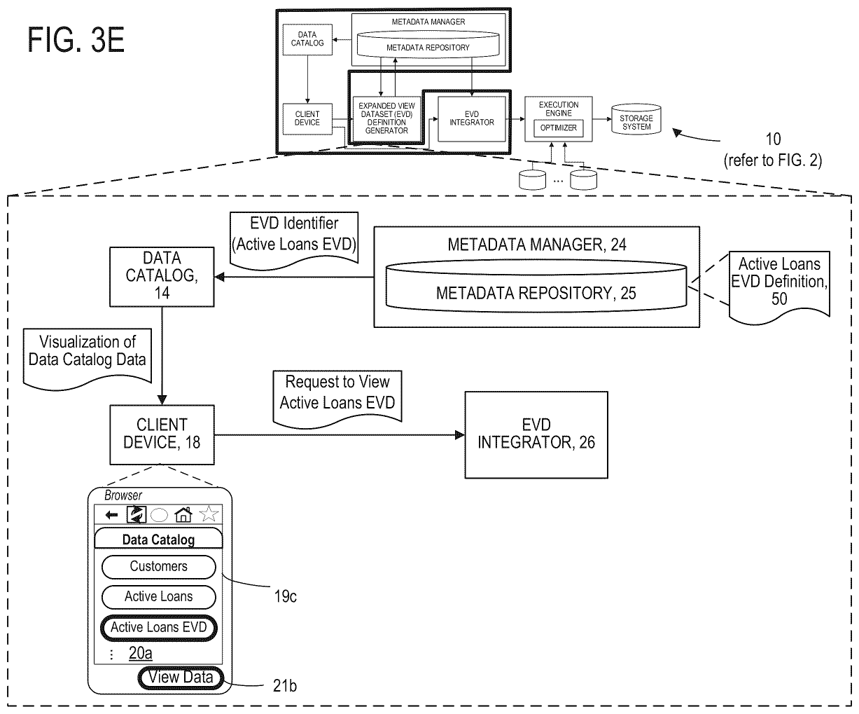

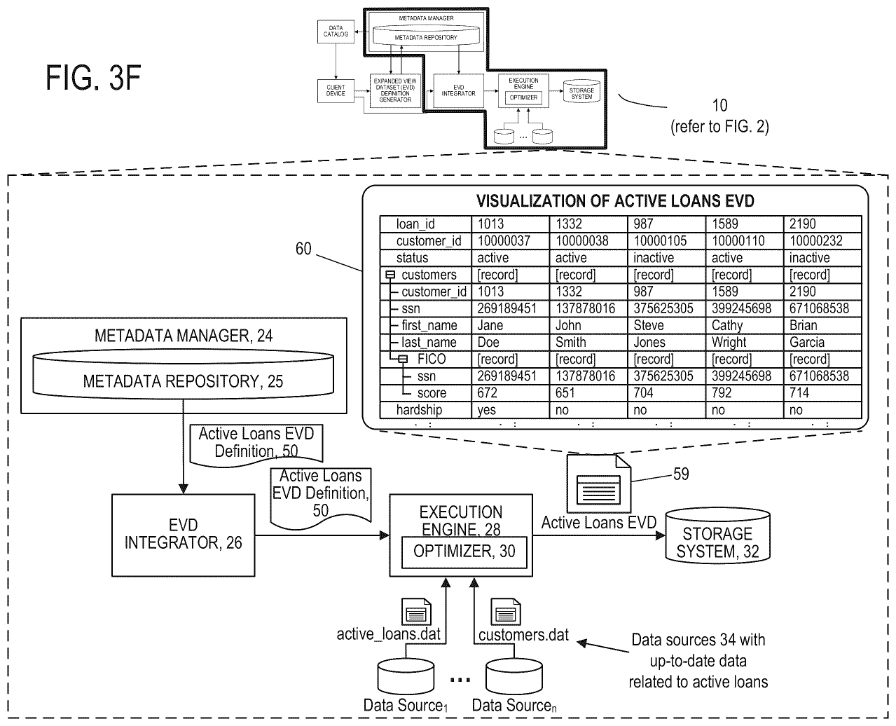

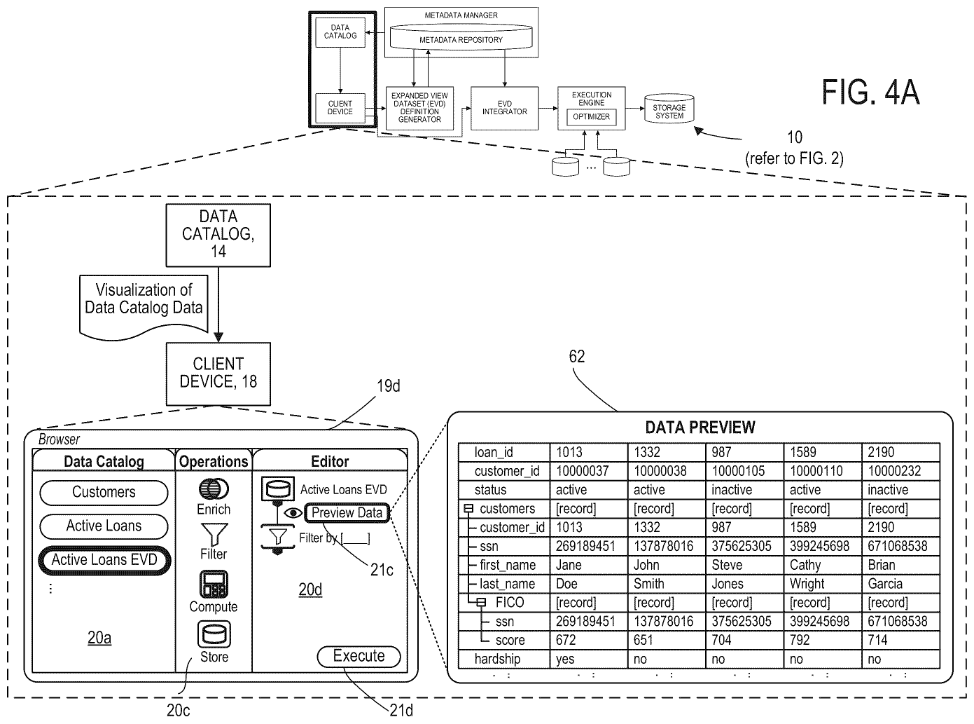

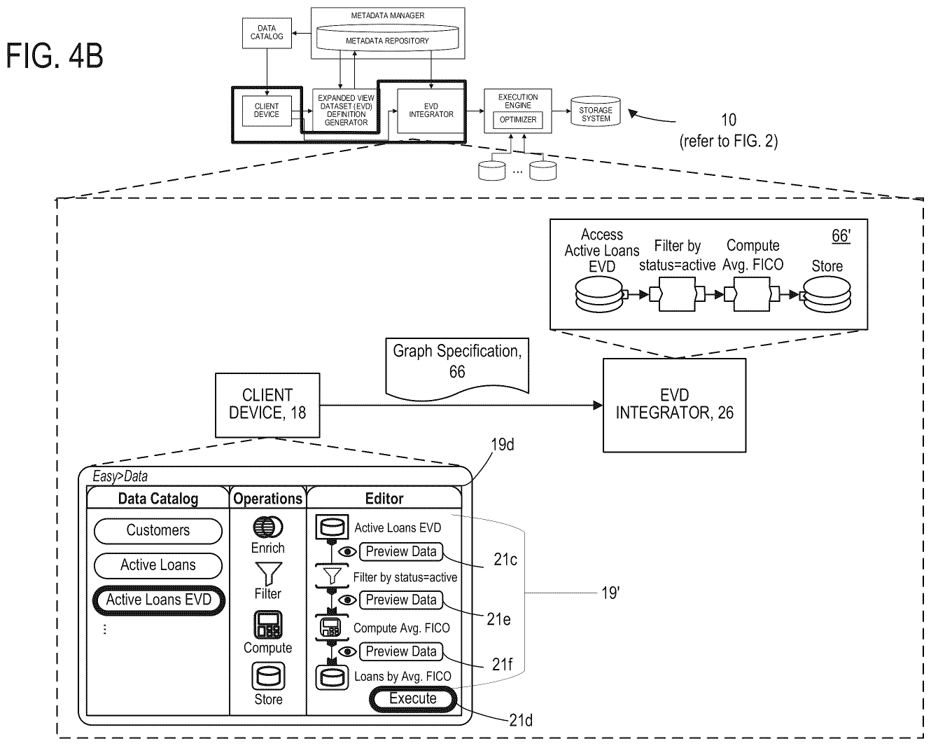

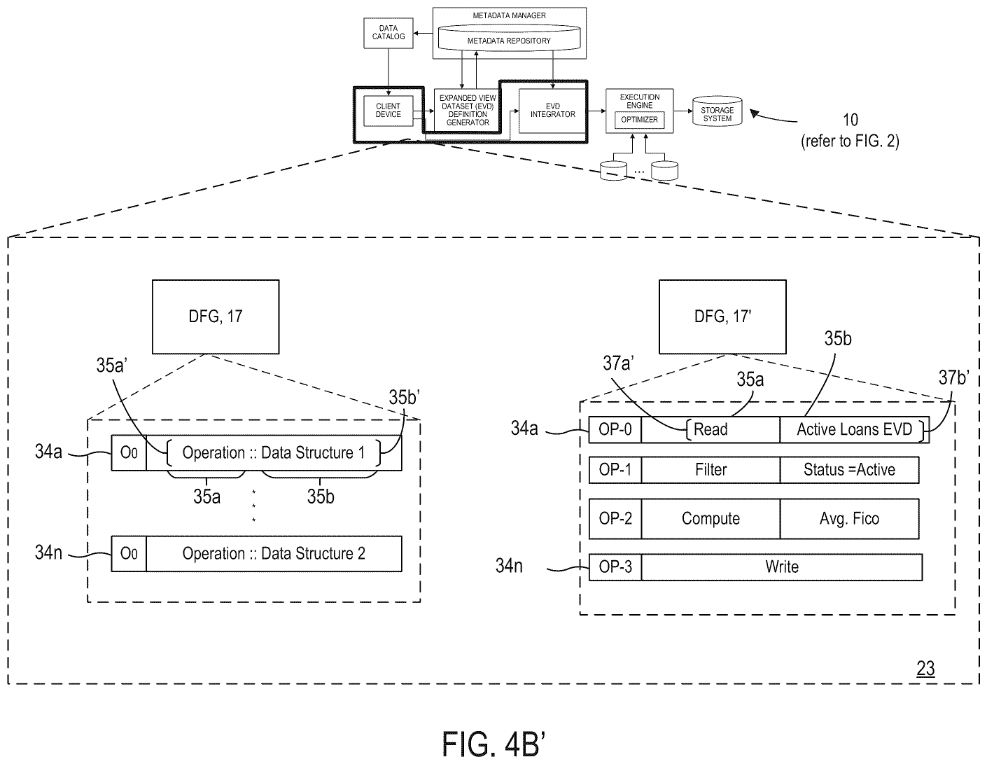

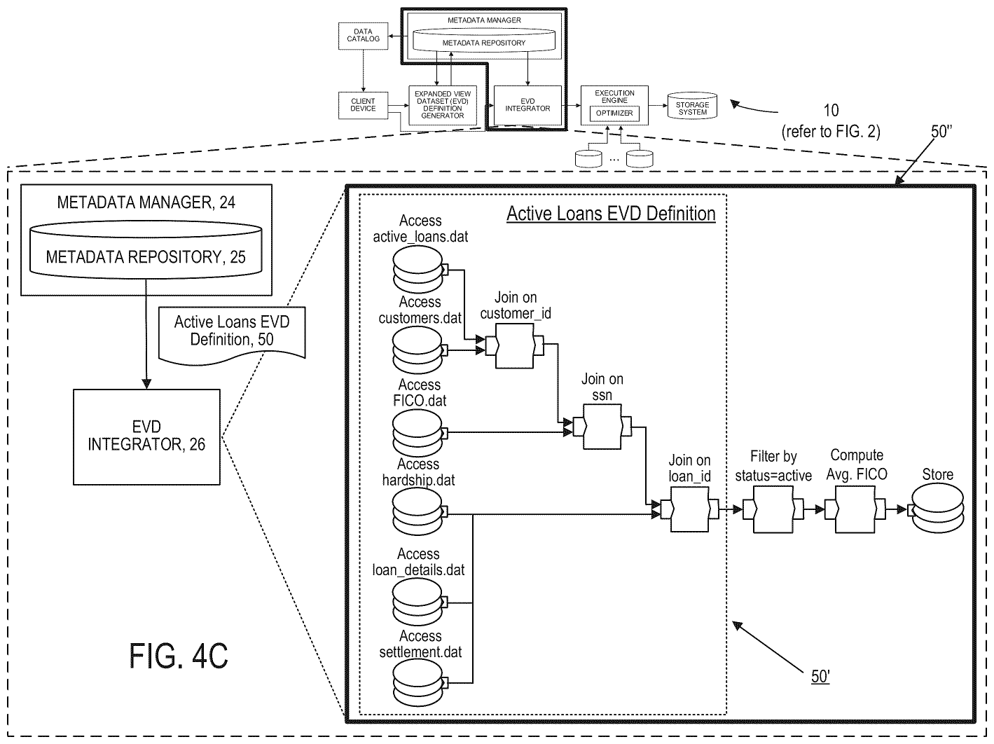

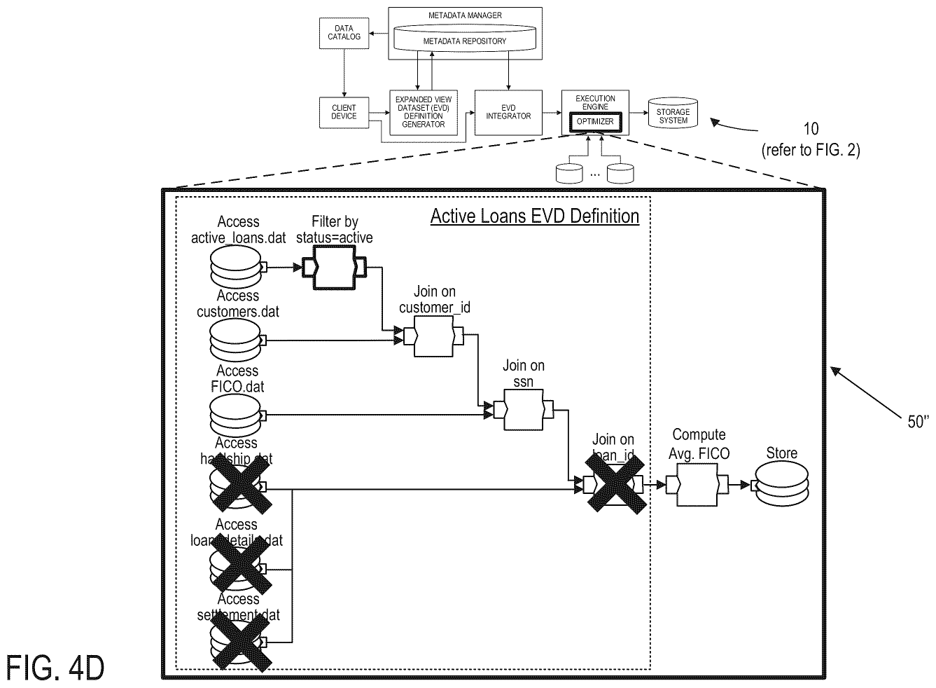

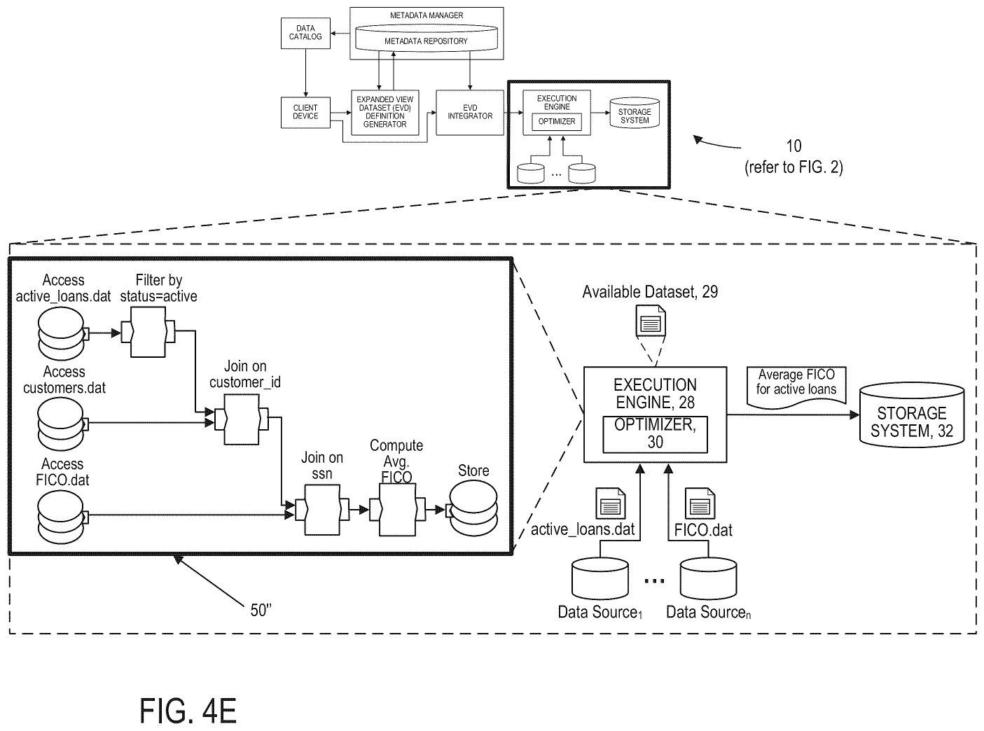

Referring to FIG. 2, a system 10 for generating a preview of attributes of fields of an expanded view dataset is shown. An expanded view dataset includes data of a base dataset and data of one or more datasets that are related to the base dataset, e.g., that are related in a database schema. A base dataset is a dataset that has been specified or selected, e.g., by a user. Generally, attributes include values of fields and/or information describing the values and/or the fields. The system 10 also enables a user to specify one or more attributes to use in one or more data processing operations that are optimized with respect to speed and data memory.

The system 10 includes a data processing system 12 and a client device 18. The client device 18 receives from a data catalog 14 data (specifying which datasets can be used for processing and/or to compute requested values) that is rendered in a browser 19 by the client device 18. A user interface 19a rendered in the browser 19 displays a section 20a (labeled “data catalog”) that displays datasets from the data catalog 14 and a section 20b (labeled “field selector”) that displays fields in the datasets. The section 20a lists datasets from the data catalog 14 and the section 20b displays fields that are in a selected one of the datasets (discussed further below). Through the user interface 19a, the user selects which data sources the user wants to preview. The user selects which data sources from across many disparate (e.g., enterprise-wide) data sources and fields in those data sources. The system 10 ultimately can automatically generate code (e.g., generates a dataflow graph) to access specific ones of the data sources across those disparate data sources.

The data catalog 14 is a repository of identifiers (e.g., indexes of business or logical names or logical metadata) of one or more datasets and fields, and other data across an entire storage infrastructure allowing a user to find and identify data more quickly. The identifiers in the data catalog 14 may be business names that are easy for a user to understand and provide semantic meaning. The data catalog 14 may also store technical identifiers (also known as technical metadata) for the datasets and fields and so forth. For example, this technical metadata may specify a technical field name, e.g., a field name as it appears in the data source itself. For each technical field name, the data catalog may store a logical or business name to enable a user to easily identify fields and datasets. In some examples, system 10 automatically transforms technical metadata to logical metadata (e.g., business names) by performing semantic discovery on data received from data sources, as described in U.S. Patent Pub. No. 2020/0380212 (Entitled “Discovering a Semantic Meaning of Data Fields from Profile Data of the Data Fields”), the entire contents of which are incorporated herein by reference.

In this example, client device 18 transmits request 13 to EVD definition generator 22. Request 13 specifies that “active loans.dat” is a base dataset and the request 13 is for an expanded view of “active loans.dat.” An expanded view includes a representation, specification, identification or listing or all datasets related to a base dataset. Responsive to the request, EVD definition generator 22 identifies datasets that are related to the base dataset and generates a definition 13a of these related datasets and the base dataset. This definition is referred to as an EVD definition, which specifies the related datasets and the base dataset and also specifies logic for generating a dataset (referred to as the expanded view dataset) that includes the data from the related datasets and the base dataset. At this stage, EVD definition generator transmits EVD definition 13a to metadata repository 25 for storage. At this time, data processing system 12 does not use EVD definition 13a to generate an expanded view dataset. The reason is because the expanded view dataset (once generated) will include many fields (e.g., all the fields from the base dataset and the related datasets). As such, materializing this dataset is costly. Materialization refers to the process of retrieving data (of fields) from various sources, combining all that data into a single dataset and then storing that combined, single dataset. This materialization is costly in terms of processing and memory resources. As such, the data processing system 12 only materializes that combined, single dataset once the fields that are required for processing have actually been specified—as described below. Additionally, the data processing system 12 displays visualizations of the fields that would be in the EVD and includes a preview of the values of those fields. The data processing system 12 generates these visualizations and the preview by using the EVD definition to process a limited or specified amount of data in the base dataset and the related datasets. In some cases, the data processing system 12 may generate visualizations of the fields that would be in the EVD without a preview of the values of those fields, thereby avoiding the need to process any data in the based dataset and the related datasets. By only processing a specified or limited amount of data, the data processing system 12 conserves processing and memory resources. As such, the data processing system 12 provides logical access (to the fields and the values of the physical), without the cost of materialization of the EVD. Logical access includes a preview of the fields and/or values of those fields to enable those fields to be used in specifying logic for a computational process.

Once these fields have been specified, then the data processing system can use the EVD definition to materialize a dataset that only includes the fields that are actually needed for processing. This materialized dataset is referred to as an available dataset because this dataset includes that fields that are required to be available for processing. In this example, the data processing system 12 does not materialize the EVD dataset. Rather, the EVD definition is used to materialize an available dataset 15.

The user interface 19a includes the section 20a that lists data catalog datasets (e.g., customers, active loans, active loans EVD), with the active loans EVD dataset being selected (bolded) and the section 20b that displays fields (e.g., loan ID, status, FICO, Customer SSN (social security number)) corresponding to the fields in the datasets, e.g., the active loans EVD dataset. The section 20b allows the user to select which fields (e.g., loan ID, status, FICO) to include in a request that is sent to an expanded view dataset (EVD) definition generator 22. In this example, the fields Customer SSN and hardship are not included in the request.

In this example, metadata manager 24 registers EVD definition 13a with data catalog 14, e.g., by transmitting to data catalog 14 information identifying the EVD that can be generated from EVD definition 13a. Based on this, section 20a displays visualization 13b indicating that Active Loans EVD is a dataset that can be used for processing and for defining logic.

The user interface 19a includes the section 20a that lists data catalog datasets (e.g., customers, active loans, active loans EVD), with the active loans EVD dataset being selected (bolded) and the section 20b that displays fields (e.g., loan ID, status, FICO, Customer SSN (social security number)) corresponding to the fields in the datasets, e.g., the active loans EVD dataset. The section 20b allows the user to select which fields (e.g., loan ID, status, FICO) to include in a request that is sent to an expanded view dataset (EVD) definition generator 22. In this example, the fields Customer SSN and hardship are not included in the request.

In this example, the user browses the data catalog 14, via the browser 19 to identify which fields and datasets that are candidate datasets to be used in computational processing. In particular, the user browses the data catalog 14 by viewing, on the client device 18, the user interface 19a, which presents identifiers and visual representations representing the logical metadata and business names in the data catalog 14.

In this example, user interface 19a displays a preview of the fields in the active loans EVD. This preview is generated by the data processing system 12 using the definition 13a to identify the fields, e.g., by accessing the datasets or metadata for the datasets specified in the definition 13a to obtain the fields in those datasets. In this example, only fields Loan ID, Status and FICO are selected. The user interface 19a also includes input instructions field “Input Instrux” that is used to select which type of request to send to the EVD definition generator 22. The user interface 19a also includes a compute button 21 to start a computation of the expanded view dataset 59 (FIG. 3F). Upon selection of compute button 21, client device 18 sends request 13c to EVD integrator 26. Request 13c is a request to compute average FICO for active loans.

The EVD integrator 26 sends a request to a metadata manager 24 to retrieve from the metadata repository 25 the EVD definition 13a, which specifies all datasets related to the active loans dataset. EVD integrator 26 receives the definition 13a. The EVD integrator 26 integrates (or combines) the request 13c to compute average FICO for active loans with the definition 13a.

The EVD integrator 26 sends the integrated request to execution engine 28. The execution engine 28 generates code for executing the integrated request. An optimizer 30 optimizes the code to only retrieve data from those datasets that include fields selected in user interface 19a. Execution of this optimized code produces available data 15, which includes only the fields required for performing the computation specified in request 13c and/or selected in user interface 19a. Execution engine 28 executes this optimized code to retrieve data from data sources with data related to active loans for the selected fields.

The execution engine 28 executes the optimized code also to perform the requested computation and stores results, e.g., average FICO scores for active loans, in storage system 32. Details on an optimizer, such as optimizer 30 are disclosed in U.S. Patent Pub. No. 2019/0370407 (Entitled “Systems and Methods for Dataflow Graph Optimization”), the entire contents of which are incorporated herein by reference.

FIGS. 3A-3F show miniature versions of the system 10 with certain boxes being highlighted in bold. Refer to FIG. 2 to show the relationship of the bolded boxes to the other elements of FIG. 2 that are not specifically numbered or shown in FIGS. 3A-3F.

Referring now to FIG. 3A, the data catalog 14 sends a visualization of the data catalog data to the client device 18. The client device 18 renders the visualization in a user interface 19b in, e.g., a browser 19. The user interface 19b includes the section 20a that lists data catalog datasets (e.g., customers, active loans) and data for active loans 20c that displays fields, e.g., loan ID, customer ID and status. The data for active loans 20c is rendered in the corresponding fields loan ID, customer ID and status. The user interface 19b also includes a control 21a “request expanded view.” The control 21a “request expanded view,” when selected, sends the “request for expanded view dataset-base dataset definition: base dataset=active loans” to the EVD definition generator 22.

Referring now to FIG. 3B, the metadata manager 24 and the metadata repository 25 sends the retrieved metadata related to active loans from the metadata repository 25 to the EVD definition generator 22. The metadata repository 25 sends the retrieved metadata (not explicitly readable in FIG. 3B) as a metadata model 40 to the EVD definition generator 22. The expanded view dataset 59 of FIG. 3F, when generated, includes data from a base dataset definition 44 and one or more related dataset definitions 46 that correspond to new datasets and are related to the base dataset definition 44, as shown in FIG. 3C.

Referring now to FIG. 3C, the EVD definition generator 22 parses the metadata model 40 (not explicitly readable in FIG. 3C) to identify a base dataset definition 44 and related dataset definitions 46. Shown in the expanded view 41 is the base dataset definition 44. The base dataset definition 44 corresponds to an active_loans.dat base dataset 44a. The active_loans.dat base dataset 44a includes two keys a primary key loan_id and a foreign key customer_id. The related dataset definitions 46 include “hardship.dat” dataset 46a, “loan_details.dat” dataset 46b, and “settlement.dat” dataset 46c, each of which are related to the active_loans.dat base dataset 44a by virtue of the “hardship.dat” dataset 46a, “loan_details.dat” dataset 46b, and “settlement.dat” dataset 46c each including the foreign key customer_id.

Also shown in the expanded view 41 are related datasets “customers.dat” dataset 46d and “FICO.dat” dataset 46e. The “active_loans.dat” base dataset 44a is related to the “customers.dat” dataset 46d by virtue of the “active_loans.dat” base dataset 44a sharing the key “customer_id” with the “customers.dat” dataset 46d (e.g., a primary-foreign key relationship). The “FICO.dat” dataset 46e in turn is related to the “customers.dat” dataset 46d by virtue of the “FICO.dat” dataset 46e sharing the key “ssn” with the “customers.dat” dataset 46d (e.g., another primary-foreign key relationship).

The expanded view 41 of the base dataset definition 44 and related dataset definitions 46 is also shown in FIG. 3C. The expanded view 41 includes the related dataset definitions 46 including “hardship.dat” 46a, “loan_details.dat” 46b, and “settlement.dat” 46c. As described below, a preview is generated from applying the set of data processing operations specified by the definition of the expanded view dataset 50 (FIG. 3F) to only a subset of the data in the base dataset 44a and the datasets related to the base dataset 44a, e.g., “hardship.dat” 46a, “loan_details.dat” 46b, and “settlement.dat” 46c, as well as “customers.dat” dataset 46d and “FICO.dat” dataset 46e.

Details on translation of the metadata model in FIG. 3C to the definition graph in FIG. 3D are disclosed in U.S. Pat. No. 11,423,083 (Entitled “Transforming a Specification into a Persistent Computer Program”) and U.S. Pat. No. 11,210,285 (Entitled “Generation of Optimized Logic from a Schema”), the entire contents of which are incorporated herein by reference.

The one or more related dataset definitions 46 have one or more relationships 43a-43e (e.g., primary-foreign key relationships) among the base dataset 44a and the one or more related datasets 46a-46e. The user registers a definition of the new dataset with the data catalog 14. The base dataset definition 44 specifies the base dataset 44a and the datasets related to the base dataset 44a. The base dataset definition 44 provides for logical access of the related datasets without incurring a computational cost of providing the related datasets 46a-46e.

From the one or more attributes, the system 10 determines a base dataset definition 44 and based on the base dataset definition 44, the system 10 determines one or more related datasets 46a-46e that are related to the base dataset 44a. Based on the determined one or more related datasets 46a-46e, the system 10 generates a definition of an expanded view dataset 59 (FIG. 3F) that specifies the base dataset 44a, the one or more related datasets 46a-46e, and one or more relationships 43a-43e among the base dataset 44a and the one or more related datasets 46a-46e.

In this example, EVD definition generator 22 includes a graph generator (not shown), as described in U.S. Pat. No. 11,210,285 (Entitled “Generation of Optimized Logic from a Schema”), the entire contents of which are incorporated herein by reference. In this example, the base dataset definition 44 and related dataset definitions 46 identified in FIG. 3C are logical data that is input into the graph generator. In this example, the graph generator is pre-configured with a specification that specifies that a graph should be generated to access and join together all the datasets in the base dataset definition 44 and in the related dataset definition 46—thus generating the EVD definition (which in this example is the Active Loans EVD definition 50 in FIG. 3D). The graph generator generates a dataflow graph (also referred to herein as a computational graph or a graph, for purposes of convenience, and without limitation) using the specification and the logical data. Generally, a dataflow graph (or a persistent computer program) is generated from a specification as follows: A specification specifies a plurality of modules to be implemented by a computer program for processing one or more values of the one or more fields in structured data item (e.g., a data record). A module may be a component in a dataflow graph or a grouping of components (e.g., a subgraph) in a dataflow graph. In this case, the plurality of modules are modules to access and join together the datasets specified by the logical data—the base dataset definition 44 and the related datasets definition 46. As such, the graph generator creates a graph with an access data component for each of the data sources represented in the base dataset definition 44 and in the related dataset definition 46. Additionally, the graph generator adds in an appropriate number of join components to join these data sources together and adds in a data sink—as described below. Additionally, this plurality of modules may include rules, instructions, components of a dataflow graph, and so forth. The system described herein transforms the specification into the computer program that implements the plurality of modules (e.g., on the logical data) by specifying a processing flow among the components or modules, as follows: for each of one or more first modules of a plurality of modules, identifying one or more second modules of the plurality of modules that each receive input that is at least partly based on an output of the first module; and formatting an output data format of the first module such that the first module outputs only one or more values of one or more fields of the structured data item that are each (i) accessible to the first module, and (ii) specified as input into at least one of the one or more second modules at least partly based on the output of the first module; and saving, in persistent memory, the computer program, with the saved computer program specifying the formatted output data format for each of the one or more first modules, as described in U.S. Pat. No. 11,423,083. The system also includes various rules specifying that the contents of each module are included in the computer program and/or translated into instructions that is in an appropriate format for the computer program. In this example, the graph generator initially generates a dataflow graph with data sources represented in the logical data. The graph generator also adds a data sink to the dataflow graph, as a dataflow graph needs a data sink. The graph generator then adds to the dataflow graph various components that the graph generator is configured to automatically add to increase computational efficiency of a dataflow graph, such as sorting components. The graph generator is also configured to add join components to appropriately join together the data from the various data sources. Instructions, parameters, or other information for accessing or joining the data sources can be included in the logical data. Finally, the graph generator may add in a transform component that includes the computational logic specified in the specification. The transform component itself may include various components or sub-components representing another dataflow graph, when the specification is transformed into a dataflow graph as described above.

Referring now to FIG. 3D, the system 10 is shown with an actual view of the EVD definition that was already defined in FIGS. 3A-3C. The EVD definition generator 22 returns the active loans EVD definition 50 as a computational graph 50′. The Active Loans EVD definition 50 provides logical access without physical cost by providing logic to how the Active Loans EVD would be generated without actually generating the dataset (i.e., the Active Loans EVD) itself and thereby having to materialize (e.g., read from the data sources and store in memory) the data needed for the Active Loans EVD. The computational graph 50′ of the active loans EVD definition 50 includes visualizations 52a-52f of access data, such as “Access active_loans.dat,” 52a “Access customers.dat,” 52b “Access FICO.dat,” 52c “Access hardship.dat,” 52d “Access loan_details.dat,” 52e and “Access settlement.dat.” 52f. These correspond to the related datasets 46a-46e of FIG. 3C.

The EVD definition generator 22 returns the computational graph 50′ that further includes join operations. These join operations include a join operation 54a applied to “Access active_loans.dat,” and “Access customers.dat,” that are joined based on “customer_id.” A join operation 54b applied to the result from the join operation 54a that is joined with “Access FICO.dat.” based on “ssn.” A join operation 54c applied to the result from the join operation 54b is joined with “Access hardship.dat” 52d being joined with “loan_id.” The “Access hardship.dat,” 52d “Access loan_details.dat,” 52e and “Access settlement.dat” 52f are shown as merged together into a single input to the join operation 54c. As described below, an available dataset is generated from this computation graph 50′, which is optimized to remove “Access hardship.dat,” 52d “Access loan_details.dat,” 52e and “Access settlement.dat” 52f as data sources-because “Access hardship.dat,” 52d “Access loan_details.dat,” 52e and “Access settlement.dat” 52f include data that is not used by downstream components in generating a specified output. That is, the “Access hardship.dat,” 52d “Access loan_details.dat,” 52e and “Access settlement.dat” 52f are optimized out, as described below.

Referring now to FIG. 3E, the active loans EVD definition 50 is sent to the metadata manager 24 and metadata repository 25. The metadata manager 24 sends an EVD identifier (active loans EVD) to the data catalog 14. The active loans EVD definition 50 is sent to the metadata manager 24 and metadata repository 25. The data catalog 14 sends the visualization of the data catalog data to the client device 18. The client device 18 renders the browser 19 with a user interface 19c that displays the section 20a (labeled “data catalog”) that displays datasets from the data catalog 14.

The browser 19 renders a user interface 19c that displays the visualization of the data catalog data and a view data button 21b. The client device 18 sends the request to view active loans EVD to the EVD integrator 26. The metadata manager 24 and metadata repository 25 in response to providing the preview, receives a specification (active loans EVD definition) that specifies the data processing operations. The data processing operations of the specification are at least partly defined based on the user input that identifies an attribute included in the preview as an attribute of that data processing operation.

Referring now to FIG. 3F, the metadata manager 24 sends the active loans EVD definition 50 from the metadata repository 25 to the EVD integrator 26. The EVD integrator 26 sends the active loans EVD definition 50 to the execution engine 28. Execution engine 28 compiles computational graph 50′ and executes the compiled graph to generate a dataset “active loans EVD,” which is generated by executing the dataflow graph that is the active loans EVD definition 50 against data in data sources 34. That is, in generating active loans EVD 59, data from data sources 34 is materialized (e.g., read from the data sources 34) and processed to provide a new dataset-active loans EVD 59, in response to the request. Execution engine 28 also produces a visualization 60 of active loans EVD 59 to enable a user to view the data in active loans EVD. In an example, the visualization may show only a specified amount of data (e.g., the first five results) to produce a visualization without latency in loading the visualization, which may be the case if the visualization included all the data (e.g., 1 million items of data) in the active loans EVD 59. The generated dataset “active loans EVD” is stored in the storage system 32 and registered with the data catalog 14.

The system 10 receives the request for the expanded view dataset 59, and in response to the request, provides the expanded view dataset 59, by retrieving, from a hardware storage device, the definition 50 of the expanded view dataset 59, and retrieves, from one or more data sources, the base dataset and the one or more other datasets, i.e., related datasets. From the expanded view dataset 59, the system 10 generates visualization 60 of expanded view dataset 59.

Described in FIGS. 4A-4E is an example of data catalog editing operations. FIGS. 4A-4E show miniature versions of the system 10 with certain boxes being highlighted in bold. Refer to FIG. 2 to show the relationship of the bolded boxes to the other elements of FIG. 2 that are not specifically numbered or shown in FIGS. 4A-4E.

Referring now to FIG. 4A, the data catalog 14 sends the visualization of the data catalog data to the client device 18. The client device renders the visualization in the browser 19 as a user interface 19d. The user interface 19d includes the data catalog 20a that lists data catalog datasets (e.g., customers, active loans, active loans EVD) and operations such as enrich, filter, compute, and store. The user interface 19d also includes an editor 20d to edit the listed data catalog datasets, e.g., “active loans EVD” dataset. Editor 20d enables a user to define a specification that is compiled into a graph and executed. The editor 20d includes a “preview” control 21c and an “execute” control 21d. Selection of the preview control 21c causes the client device to generate a data preview 62. In FIG. 4A, the generated data preview 62 corresponds to the visualization 60 of active loans EVD 59 of FIG. 3F.

In this example, data preview 62 provides logical access without physical cost, meaning that preview 62 is generated by executing Active Loans EVD definition 50 on only a few records in data sources 34, rather than executing Active Loans EVD definition 50 on all the data records in data sources 34, which would consume significant memory and processing resources collecting data for fields that may never be used (e.g., data for fields that are not used or accessed by the specification defined in editor 20d. However, the user is provided logical access to all the fields because the user can view the fields defined in definition 50 and even view values for those fields in deciding which fields the user wants to use in the specification (e.g., which fields the user wants to filter by). Then when the actual dataset (Active Loans EVD) is materialized (e.g., generated), it can be optimized to only materialize those fields that are being used by the data processing operations defined by the specification in editor 20d.

Referring now to FIG. 4B, the client device 18 renders the visualization in the browser 19 as a user interface 19d. The client device 18 sends a graph specification to the EVD integrator 26. The user interface 19d includes the data catalog 20a that lists data catalog datasets (e.g., customers, active loans, active loans EVD) and operations such as enrich, filter, compute, and store. The user interface 19d also includes the editor 20d to edit the listed data catalog datasets, e.g., “active loans EVD” dataset. The editor 20d includes the “preview” control 21c and the “execute” control 21d, and also includes additional preview control 21e to preview “filter by status=active” and additional preview control 21f to “preview compute Avg. FICO.” Selection of the preview controls 21c, 21e and 21f causes the client device 18 to send instructions to the EVD integrator 26 to generate a corresponding data preview (not shown). Examples of graph specifications, as in FIG. 4B, that are translated into executable code are given in U.S. Patent Pub. No. 2021/0232579 (Entitled “Editor for Generating Computational Graphs”), the entire contents of which are incorporated herein by reference.

In this example, graph 19′ is generated in editor 19d. Graph 19′ is an example of a declarative graph, in which each component represents a declarative operation—that is subsequently transformed into an imperative operation as described herein. Client device 18 transmits graph specification 66 to EVD integrator 26. Graph specification 66 represents and/or specifies the contents of graph 19′. Based on graph specification 66, EVD integrator 26 generates graph 66′, as described in U.S. Pat. No. 11,593,380.

In this example, graph specification 66 includes selection data specifying which icons in user interface 19d have been selected and other information and/or value specified in user interface 19d. EVD integrator 26 includes a dataflow graph engine (not shown) that receives the selection data from the client device 18. The selection data indicates the data sources, data sinks, and data processing functionality for a desired computational graph. A user of the client device 18 need not specify data access details or other low-level implementation details, as these details can be derived by the dataflow graph engine. Based on the selection data, the dataflow graph engine generates a dataflow graph 66′ or modifies a previously created dataflow graph. In some examples, the dataflow graph engine transforms the dataflow graph by, for example, removing redundancies in the dataflow graph, adding sorts or partitions to the dataflow graph, and specifying intermediate metadata (e.g., metadata for translating or otherwise transforming the dataflow graph), among other optimizations and transforms. The EVD integrator 26 transmits dataflow graph 66′ to execution engine 28, which includes a compiler that compiles the dataflow graph 66′ into a compiled computational graph (e.g., an executable program).

Referring to FIG. 4B′, an example of generating dataflow graph 66′ from graph specification 66 is now described. In this example, using graph specification 66, EVD integrator 26 generates dataflow graph 17 (sometimes referred to as an “initial dataflow graph” or a “preliminary data flow graph”), which represents core constructs of compiled graphs, such as the transformed dataflow graph 50″ (FIG. 4C), which have nodes (or components). The dataflow graph 17 optionally includes parameters (e.g., a name, a value, a location, an interpretation). In some implementations, the dataflow graph 17 includes input and output ports on the graph itself, as in a graph intended to be used as a subgraph.

In some implementations, a node (or component) possesses or is of a node “kind” that indicates the behavior or function of the node. The node kind is used to select a prototype for a node, to facilitate pattern matching (e.g., to find a sort node followed by a sort node), and to determine what component is instantiated in the transformed dataflow graph 50″ (or 66′ depending on the level of transformation). For example, a trash node in the dataflow graph 23 can be instantiated as a trash node in the transformed dataflow graph 66′. A node (or component) can include input ports, output ports, and parameters, as discussed below.

A node optionally has a label which identifies the node. In some implementations, if a node does not have a label, the system assigns a label to the node. Node labels can include an arbitrary collection of alphanumeric characters, whitespace, and punctuation and do not have to be unique (but can be made unique during translation to a graph). The system can use the node label to refer to a node (or the node's input ports, output ports, or parameters) to, for example, define the input or output of the node or the data flow between nodes.

In some examples, prior to generation of dataflow graph 17, EVD integrator 26 includes a template dataflow graph, dataflow graph 17. The dataflow graph 17 is shown as including nodes 34a through 34n. Each of the nodes 34a-34n include at least one operation placeholder field and at least one data placeholder field. For example, the “initial” node 34a has an operation placeholder field 35a to hold one or more operation elements 35a′ and a data placeholder field 35b to hold one or more data source or a data sink elements 35b′. The operation elements 35a′ can specify code or a location of code that will perform a function on data input to or output from the initial node 34a. The data source or data sink elements 35b′ can specify the data source or data sink, or a location of the data source or data sink, for the initial node 34a (for the function of the initial node 34a). In some implementations, the elements 35a′ or the elements 35b′, or both, include links or addresses to a storage system included in EVD integrator 26 or storage system 32, such as a link to a database or a pointer to code included in the storage system 32. In some implementations, the elements 35a′ or the elements 35b′, or both, include a script.

During construction of the dataflow graph 17, each of the nodes 34a-34n can be modified by retrieving the operation elements to be placed in the operation placeholder field and the data source or data sink elements to be placed in the data placeholder field to populate the respective fields. For example, the initial node 34a is modified during construction by retrieving (e.g., based on an operation specified by specification 66 and from a storage system) the operation elements 35a′ to populate the operation placeholder field 35a with the specified function or a link pointing to the function, and by retrieving the data source or the data sink elements 35b′ to populate the data placeholder field 35b with a link pointing to the source or the sink for the data. Upon completing the modification of a particular node 34a-34n, the node can be labeled to provide a labeled node. After each of the nodes 34a-34n have been modified (and labeled), the completed dataflow graph 17 is stored (e.g., in the storage system 32) and used to generate other dataflow graphs, as described below.

In some implementations, each of the nodes 34a-34n of the dataflow graph 17 are initially unmodified. For example, each of the nodes 34a-34n can have an empty operation placeholder field 35a and data placeholder field 35b that are subsequently modified to include the specified operation elements 35a′ and data source or data sink elements 35b′, as described above. In some implementations, the dataflow graph 17 is a previously completed dataflow graph, and some or all of the nodes 34a-34n have corresponding operation placeholder fields 35a holding operation elements 35a′ and data placeholder fields 35b holding data source or data sink elements 35b′. Such a completed dataflow graph 17 can be further modified (e.g., by retrieving additional or alternative elements 35a′, 35b′ to be placed in the respective fields 35a, 35b) and stored as a new or modified dataflow graph.

In some implementations, a particular node, such as the initial node 34a, is “reused” to produce a new, optionally labeled node that is associated with the prior node 34a. This iterative process of producing new nodes from the initial node 34a continues until a user has specified functionality for the desired computational graph. Upon completion of the iterative process, a completed dataflow graph 17 is provided. The completed dataflow graph 17 includes a plurality of nodes 34a through 34n that were instantiated from, for example, the initial node 34a. The completed dataflow graph 17 can be stored (e.g., in the storage system 32) and used to generate other dataflow graphs, as described below.

FIG. 4B′ also illustrates one implementation of a completed (e.g., modified) dataflow graph 17′. The modified dataflow graph 17′ is shown as including four nodes labeled OP-0 to OP-3 with corresponding operation placeholder fields 35a holding operation elements and data placeholder fields 35b holding data source or data sink elements. For example, the node 34a labeled OP-0 includes a read operation element 37a′ indicating that the ‘Dataset I’ data source element 37b′ is to be read. The modified dataflow graph 17′ is stored in the storage system 32 as, for example, a data structure.

In general, the execution engine 28 performs optimizations or other transforms that may be required for processing data in accordance with one or more of the operations specified in the dataflow graph 17′, or to improve processing data in accordance with one or more of the operations specified in the dataflow graph 17′, relative to processing data without the optimizations or transforms, or both. For example, the execution engine 28 adds one or more sort operations, data type operations, join operations, including join operations based on a key specified in the dataflow graph 17′, partition operations, automatic parallelism operations, or operations to specify metadata, among others, to produce a transformed dataflow graph 50″ (FIG. 4D) having the desired functionality of the dataflow graph 17′. In some implementations, the transformed dataflow graph 50″ is (or is transformed into) an optimized dataflow graph by applying one or more dataflow graph optimization rules to the transformed dataflow graph to improve the computational efficiency of the transformed dataflow graph, relative to a computational efficiency of the transformed dataflow graph prior to applying the optimizations. The dataflow graph optimization rules can include, for example, dead or redundant component elimination, early filtering, or record narrowing, among others, as described below in context of FIG. 4D.

Referring now to FIG. 4C, the metadata manager 24 and metadata repository 25 sends the active loans EVD definition 50 to the EVD integrator 26. Based on graph 66′ and active loans EVD definition 50, EVD integrator 26 generates data flow graph 50″, as follows—for example. Using the active loans EVD definition 50, EVD integrator 26 adds nodes to graph 17′ that are necessary to generate active loans EVD. In this example, EVD integrator 26 includes logic to insert active loans EVD definition (as shown by graph 50′ in FIG. 3D) into graph 17′ by removing the Access Active Loans EVD component from graph 66′ and replacing it with a version of graph 50′, in which write component 56 (FIG. 3D) is removed from graph 50′. By doing so, the EVD integrator 26 generates the computational graph 50′ with the added operations of filter by status=active and compute Ave. FICO, and store to thus generate computational graph 50″.

Referring now to FIG. 4D, the execution engine 28 and optimizer 30 optimizes computational graph 50″ to, for example, remove components that are not actually being used, among other optimizations. In this example, the compute avg. FICO component does not need data from the following data sources: access hardship.dat, access loan details.dat or access settlement.dat. As such, reading data from these data sources would result in the reading of data that is never used by downstream components. This would result in wasted memory and computational resources. To ensure that computational graph 50″ is computationally efficient and does not waste memory and processing resources in retrieving data that is not used, optimizer 30 includes optimizer rules and logic that are configured to analyze the components of a data flow graph and remove components (e.g., read components) that are not used by downstream components. As such, generation of available dataset 29 (FIG. 4E) is computationally efficient, with decreased usage of memory and processing resources-relative to an amount of processing and memory resources used in generating an available dataset that includes all the data sources specified in the Active Loans EVD Definition. In this example, downstream refers to a component whose input is based on the output of another component. Based on this, execution engine 28 and optimizer 30 executes data processing operations (e.g., including optimization rules and/or data processing operations) to generate a computational graph “active loans EVD definition” that includes only a subset of data that would have been included in the expanded view dataset definition 50. The active loans EVD definition computational graph 50″ includes “Access active_loans.dat,” “Access customers.dat,” and “Access FICO.dat.” The active loans EVD definition computational graph 50″ has the “Access active_loans.dat,” filter by status-active, and in this example specifically excludes “Access hardship.dat,” “Access loan_details.dat,” and “Access settlement.dat.” The execution engine 28 and optimizer 30 performs the join operations on “Access active_loans.dat,” (filtered by status-active) and “Access customers.dat” join on customer_id 54a. The “Access FICO.dat” and joined on customer_id 54a are joined on ssn 54b. This result is passed to the compute avg. FICO and the generated dataset “active loans EVD” is stored in the storage system 32.

The bolded “X's” in FIG. 4D indicate portions of the computation graph 50′ (FIG. 4C) that are not included in the computational graph 50″ of FIG. 4D. That is, the datasets “Access hardship.dat,” “Access loan_details.dat,” and “Access settlement.dat.” are excluded from the computation graph 50″ based on optimization, as disclosed in U.S. Patent Pub. No. 2019/0370407.

In this example, referring back to FIG. 4B, the specification (also referred to herein as graph specification) represented in the editor specifies that from Active Loans EVD, the data is sorted by status=active and then an average FICO score is computed. As such, in accordance with the specification, not all of the datasets represented in the Active Loans EVD are actually needed to perform the computations specified in the editor. Active_loans.dat is required, as this is the base dataset. Additionally, FICO.dat is needed, as the specification specifies that the average FICO score is computed per user. Customers.dat is needed as this dataset has the keys needed to relate FICO.dat to active_loans.dat. In this example, hardship.dat, loan_details.dat and settlement.dat are not required for the processing represented by the specification. As such, the optimizer 30 removes reference to those data sources in the Active Loans EVD definition 50. By removing reference to those data sources, the active loans EVD-when generated-does not include unnecessary fields and data that are not used by the data processing operations specified in the specification. In this example, the active loans EVD is referred to as the available dataset, because the active loans EVD that is actually generated only includes (and thus makes available) data that is used by the data processing operations specified in the specification. As such, the available dataset is highly efficient in terms of speed (both for generating the available dataset and for processing it) and memory (because the system does not have to save data as part of the available dataset that is never used).

Referring now to FIG. 4E, the execution engine 28 and optimizer 30 executes the computational graph “active loans EVD definition” that includes only the subset of data that would have been included in the expanded view dataset. The active loans EVD definition computational graph 50″ includes “Access active_loans.dat,” “Access customers.dat,” and “Access FICO.dat.” The active loans EVD definition computational graph 50″ has the “Access active_loans.dat,” filter by status=active, and in this example specifically excludes “Access hardship.dat,” “Access loan_details.dat,” and “Access settlement.dat.” In executing the compiled version of computational graph 50″, execution engine 28 generates available dataset 29, e.g., upon completion of the “Join on ssn” component and prior to execution of the “Compute Avg. FICO” component. Available dataset 29 only includes data from active_loans.dat, customers.dat and FICO.dat, as previously described. In this example, available dataset 29 includes all the data in those three data sources, rather than implying generating a preview with only a subset of the data in those data sources. The execution engine 28 and optimizer 30 performs the join operations on “Access active_loans.dat,” (filtered by status=active) and “Access customers.dat” join on customer_id 54a. The “Access FICO.dat” and joined on customer_id 54a are joined on ssn 54b. The computational graph 50″ computes average FICO score and stores results.

The computational graph 50″ performs the computations directly. The computational graph 50″ obtains required data for the individual components represented by graph components and moves data between the components and defines a running order for computation processes. Execution engine 28 can also provide monitoring of the execution of the computational graph 50″. Results of executing the computational graph 50″ active loans EVD″ are stored in the storage system 32, via the store component in the computational graph 50″.

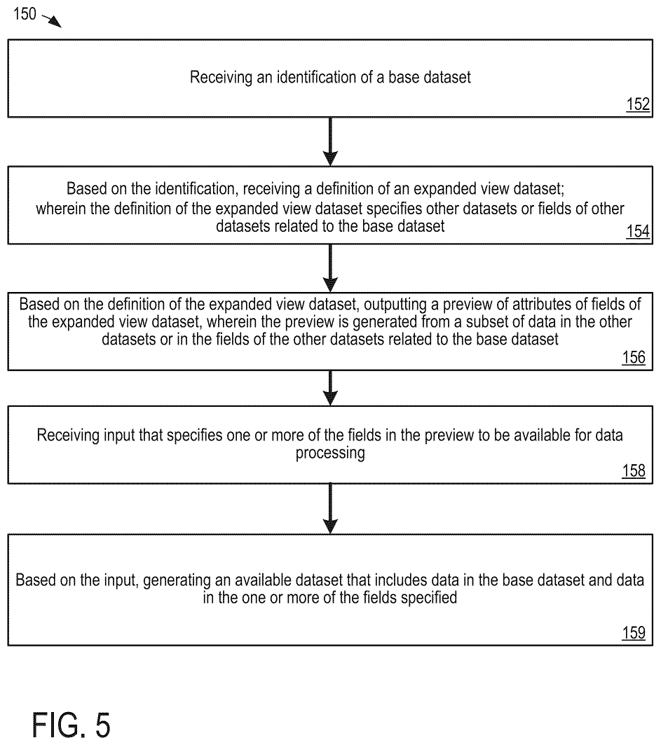

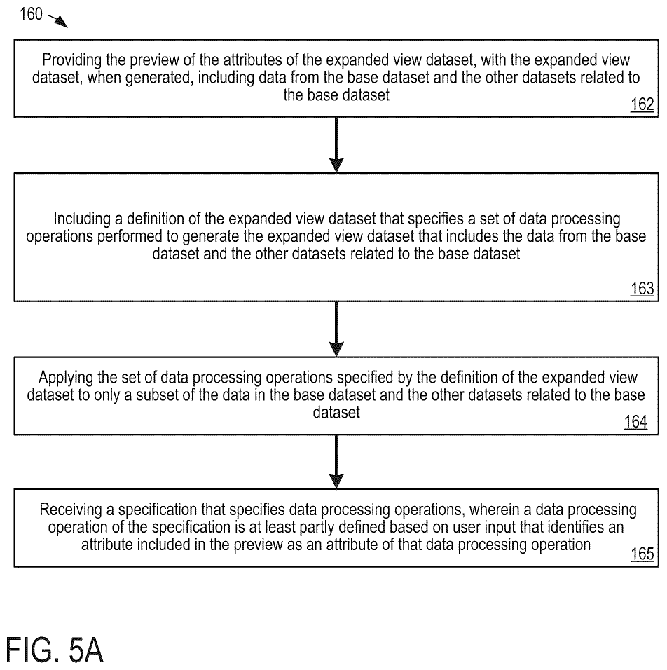

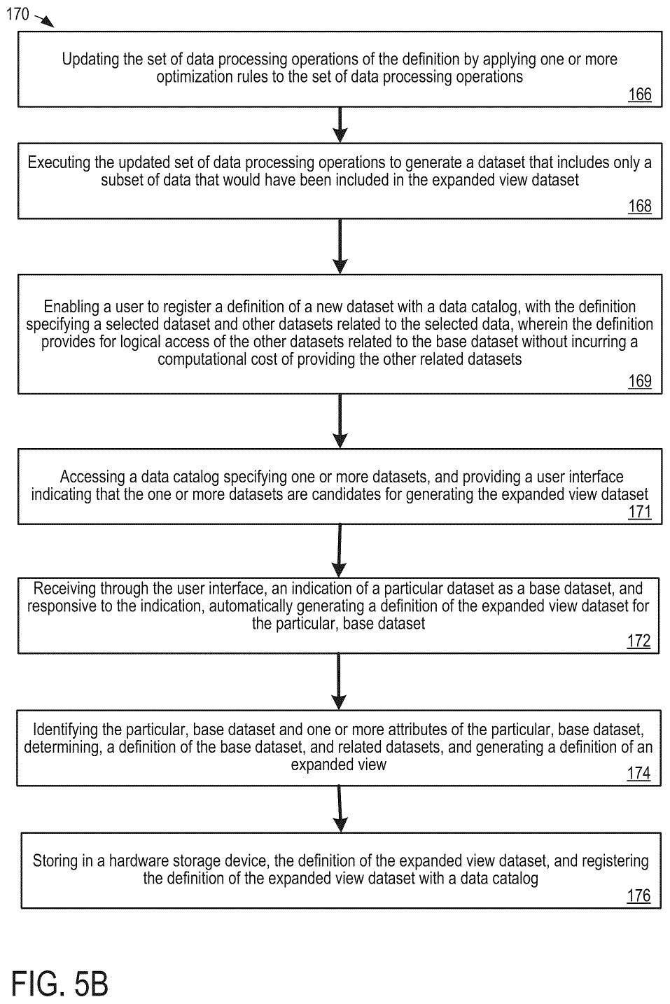

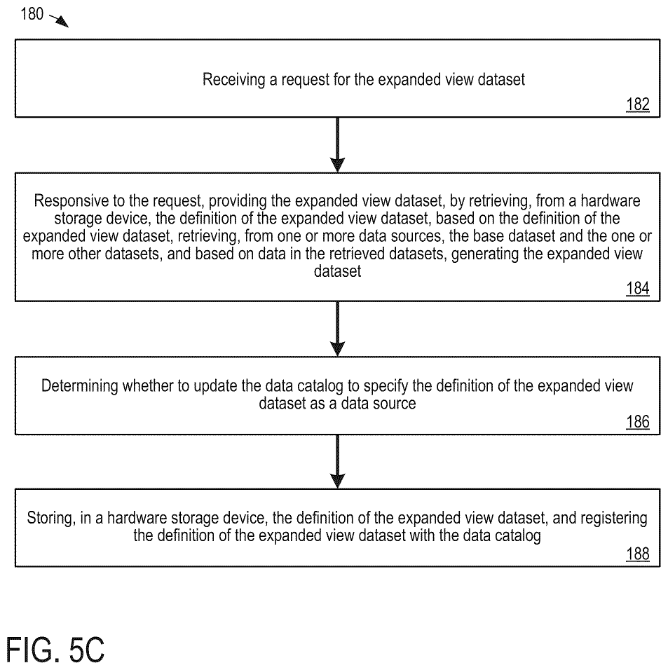

Referring now to FIG. 5, a process 150 executed by a data processing system 12 for enabling a user to preview attributes of fields of an expanded view dataset and for empowering the user to specify one or more attributes to use in one or more data processing operations that are optimized with respect to speed and data memory is shown. The process 150 enables a user to specify one or more of the fields to use in downstream data processing for generating a dataset that includes the one or more of the fields from the preview specified to be used in the downstream data processing, with the generated dataset having increased efficiency with respect to speed and data memory, relative to an efficiency of generating a dataset including all the fields of the expanded view when only the specified one or more of the fields are used in the downstream data.

The process 150 includes receiving 152 an identification of a base dataset, and based on the identification, receiving 154 a definition of an expanded view dataset. The definition of the expanded view dataset specifies other datasets or fields of other datasets related to the base dataset. Based on the definition of the expanded view dataset, the process 150 includes outputting 156 a preview of attributes of fields of the expanded view dataset, in which the preview is generated from a subset of data in the other datasets or in the fields of the other datasets related to the base dataset. The process 150 also includes receiving 158 input that specifies one or more of the fields in the preview to be available for data processing, and based on the input, generating 159 an available dataset that includes data in the base dataset and data in the one or more of the fields specified.

Referring now to FIG. 5A, the process 160 may include other features such as providing 162 the preview of the attributes of the expanded view dataset, with the expanded view dataset, when generated, including data from the base dataset and the other datasets related to the base dataset. The process 160 may include 163 a definition of the expanded view dataset that specifies a set of data processing operations performed to generate the expanded view dataset that includes the data from the base dataset and the other datasets related to the base dataset, in which the preview is generated from applying 164 the set of data processing operations specified by the definition of the expanded view dataset to only a subset of the data in the base dataset and the other datasets related to the base dataset. Responsive to providing the preview, the process 160 includes receiving 165 a specification that specifies data processing operations, in which a data processing operation of the specification is at least partly defined based on user input that identifies an attribute included in the preview as an attribute of that data processing operation.

Referring now to FIG. 5B, based on the data processing operation that is at least partly defined based on the user input that identifies the attribute included in the preview as the attribute of that data processing operation, the process 170 may include updating 166 the set of data processing operations of the definition by applying one or more optimization rules to the set of data processing operations, and executing 168 the updated set of data processing operations to generate a dataset that includes only a subset of data that would have been included in the expanded view dataset.

The process 170 may include enabling 169 a user to register a definition of a new dataset with a data catalog, with the definition specifying a selected dataset and other datasets related to the selected data, thereby providing for logical access of the other datasets related to the base dataset without incurring a computational cost of providing the other related datasets. The process 170 may include accessing 171 a data catalog specifying one or more datasets, and providing a user interface indicating that the one or more datasets are candidates for generating the expanded view dataset. The process 170 may include receiving 172, through the user interface, an indication of a particular dataset as a base dataset, and responsive to the indication, automatically generating a definition of the expanded view dataset for the particular, base dataset.

The process 170 may include identifying 174 the particular, base dataset as the base dataset and one or more attributes of the particular, base dataset, determining, from the one or more attributes, a definition of the base dataset, based on the definition of the base dataset, determining, the one or more other datasets that are related to the base dataset, and based on the determined one or more other datasets, generating a definition of an expanded view dataset that specifies the base dataset, the one or more other datasets and one or more relationships among the base dataset and the one or more other datasets.

The process 170 may include storing 176, in a hardware storage device, the definition of the expanded view dataset, and registering the definition of the expanded view dataset with a data catalog.

Referring now to FIG. 5C, a process 180 may include receiving 182 a request for the expanded view dataset, responsive to the request, providing 184 the expanded view dataset, by retrieving, from a hardware storage device, the definition of the expanded view dataset, based on the definition of the expanded view dataset, retrieving, from one or more data sources, the base dataset and the one or more other datasets, and based on data in the retrieved datasets, generating the expanded view dataset.

The process 180 may include based on the expanded view dataset, determining 186 whether to update the data catalog to specify the definition of the expanded view dataset as a data source, storing 188 in a hardware storage device, the definition of the expanded view dataset, and registering the definition of the expanded view dataset with the data catalog. The process 180 may include receiving a request for the expanded view dataset, responsive to the request, generating the expanded view dataset, by retrieving, from a hardware storage device, the definition of the expanded view dataset, based on the definition of the expanded view dataset, retrieving, from one or more data sources, the base dataset and the one or more other datasets, and based on data in the retrieved datasets, generating the expanded view dataset.

Dataflow graph components include data processing components and/or datasets. A dataflow graph can be represented by a directed graph that includes nodes or vertices, representing the dataflow graph components, connected by directed links or data flow connections, representing flows of work elements (i.e., data) between the dataflow graph components. The data processing components include code for processing data from at least one data input, (e.g., a data source) and providing data to at least one data output, (e.g., a data sink) of the system 10. The dataflow graph can thus implement a graph-based computation performed on data flowing from one or more input datasets through the graph components to one or more output datasets.

System 10 also includes the data processing system 12 for executing one or more computer programs (such as dataflow graphs), which were generated by the transformation of a specification into the computer program(s) using a transform generator and techniques described herein. The transform generator transforms the specification into the computer program that implements the plurality of modules. In this example, the selections made by user through the user interfaces described here form a specification that specify which fields and datasets are used in the complex aggregation. Based on the specification, the transforms described herein are generated.

The data processing system 12 may be hosted on one or more general-purpose computers under the control of a suitable operating system, such as the UNIX operating system. For example, the data processing system 12 can include a multiple-node parallel computing environment including a configuration of computer systems using multiple central processing units (CPUs), either local (e.g., multiprocessor systems such as SMP computers), or locally distributed (e.g., multiple processors coupled as clusters or MPPs), or remotely distributed (e.g., multiple processors coupled via LAN or WAN networks), or any combination thereof.

The graph configuration approach described above can be implemented using software for execution on a computer. For instance, the software forms procedures in one or more computer programs that execute on one or more systems 10, e.g., computer programmed or computer programmable systems (which may be of various architectures such as distributed, client/server, or grid) each including at least one processor, at least one data storage system (including volatile and non-volatile memory and/or storage elements), at least one input device or port, and at least one output device or port. The software may form one or more modules of a larger computer program, for example, that provides other services related to the design and configuration of dataflow graphs. The nodes and elements of the graph can be implemented as data structures stored in a computer readable medium or other organized data conforming to a data model stored in a data repository.

The software may be provided on a non-transitory storage medium, such as a hardware storage device, e.g., a CD-ROM, readable by a general or special purpose programmable computer or delivered (encoded in a propagated signal) over a communication medium of a network to the computer where it is executed. All of the functions may be performed on a special purpose computer, or using special-purpose hardware, such as coprocessors. The software may be implemented in a distributed manner in which different parts of the dataflow specified by the software are performed by different computers. Each such computer program is preferably stored on or downloaded to a non-transitory storage media or hardware storage device (e.g., solid state memory or media, or magnetic or optical media) readable by a general or special purpose programmable computer, for configuring and operating the computer when the non-transitory storage media or device is read by the system 10 to perform the procedures described herein. The system 10 may also be considered to be implemented as a computer-readable storage medium, configured with a computer program, where the storage medium so configured causes the system 10 to operate in a specific and predefined manner to perform the functions described herein.

### Example Computing Environment

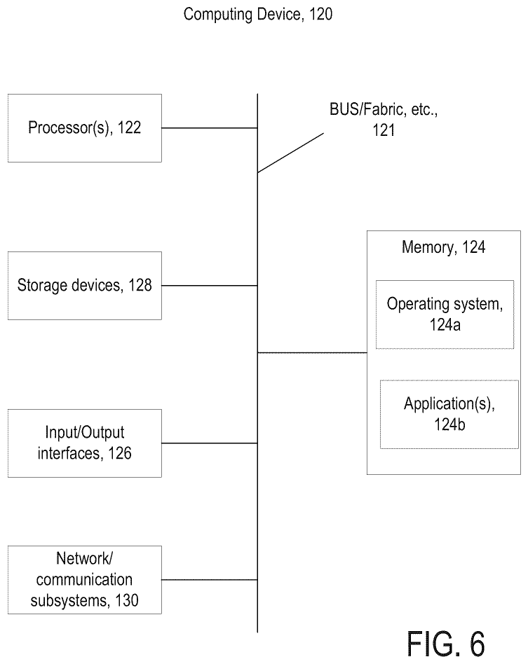

Referring to FIG. 6, an example operating environment for implementing embodiments of the present invention is shown and designated generally as computing device 120. Essential elements of a computing device 120 or a computer or data processing system or client or server are one or more programmable processors 122 for performing actions in accordance with instructions and one or more memory devices 124 for storing instructions and data. Generally, a computer will also include, or be operatively coupled, (via bus 121, fabric, network, etc.), to I/O components 126, e.g., display devices, network/communication subsystems, etc. (not shown) and one or more mass storage devices 128 for storing data and instructions, etc., and a network communication subsystem 130, which are powered by a power supply (not shown). In memory 124, are an operating system 124a and applications 124b for application programming.

Devices suitable for storing computer program instructions and data include all forms of non-volatile memory, media and memory devices including by way of example, semiconductor memory devices (e.g., EPROM, EEPROM, and flash memory devices), magnetic disks (e.g., internal hard disks or removable disks), magneto optical disks, and CD ROM and DVD-ROM disks. The processor and the memory can be supplemented by, or incorporated in, special purpose logic circuitry.

To provide for interaction with a user, embodiments of the subject matter described in this specification are implemented on a computer having a display device (monitor) for displaying information to the user and a keyboard, a pointing device, (e.g., a mouse or a trackball) by which the user can provide input to the computer. In addition, a computer can interact with a user by sending documents to and receiving documents from a device that is used by the user (for example, by sending web pages to a web browser on a user's user device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the user device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the techniques described herein. For example, some of the steps described above may be order independent, and thus can be performed in an order different from that described. Additionally, any of the foregoing techniques described with regard to a dataflow graph can also be implemented and executed with regard to a program. Accordingly, other embodiments are within the scope of the following claims.

What is claimed is:

1. A method implemented by a data processing system for: enabling a user to preview attributes of fields of an expanded view of a base dataset and to specify one or more of the fields to use in downstream data processing and generating a dataset that includes the one or more of the fields from the preview specified to be used in the downstream data processing, with the generated dataset having increased efficiency with respect to speed and data memory, relative to an efficiency of generating a dataset including all the fields of the expanded view when only the specified one or more of the fields are used in the downstream data processing, including:
receiving an identification of a base dataset,
based on the identification, receiving a definition of an expanded view dataset,
wherein the definition of the expanded view dataset specifies other datasets or fields of other datasets related to the base dataset,
based on the definition of the expanded view dataset, outputting a preview of attributes of fields of the expanded view dataset, wherein the preview is generated from a subset of data in the other datasets or in the fields of the other datasets related to the base dataset,
receiving input that specifies one or more of the fields in the preview to be available for data processing, and
based on the input, generating an available dataset that includes data in the base dataset and data in the one or more of the fields specified.

2. The method of claim 1, further including:
providing the preview of the attributes of the expanded view dataset, with the expanded view dataset, when generated, including data from the base dataset and the other datasets related to the base dataset.

3. The method of claim 2 wherein the definition of the expanded view dataset specifies a set of data processing operations performed to generate the expanded view dataset that includes the data from the base dataset and the other datasets related to the base dataset, and
wherein the preview is generated from applying the set of data processing operations specified by the definition of the expanded view dataset to only a subset of the data in the base dataset and the other datasets related to the base dataset.

4. The method of claim 2, further including:
responsive to providing the preview, receiving a specification that specifies data processing operations, wherein a data processing operation of the specification is at least partly defined based on user input that identifies an attribute included in the preview as an attribute of that data processing operation.

5. The method of claim 3, further including:
based on the data processing operation that is at least partly defined based on the user input that identifies the attribute included in the preview as the attribute of that data processing operation, updating the set of data processing operations of the definition by applying one or more optimization rules to the set of data processing operations, and
executing the updated set of data processing operations to generate a dataset that includes only a subset of data that would have been included in the expanded view dataset.

6. The method of claim 1, further including:
enabling a user to register a definition of a new dataset with a data catalog, with the definition of the new dataset specifying a selected dataset and other datasets related to the selected data, wherein the definition provides for logical access of the other datasets related to the base dataset without incurring a computational cost of providing the other related datasets.

7. The method of claim 6, further including:
accessing a data catalog specifying one or more datasets, and
providing a user interface indicating that the one or more datasets are candidates for generating the expanded view dataset.

8. The method of claim 7, further including:
receiving, through the user interface, an indication of a particular dataset as the base dataset, and
responsive to the indication, automatically generating a definition of the expanded view dataset for the particular dataset.

9. The method of claim 8, further including:
identifying the particular dataset as the base dataset and one or more attributes of the particular dataset,
determining, from the one or more attributes, a definition of the base dataset,
based on the definition of the base dataset, determining, the one or more other datasets that are related to the base dataset, and
based on the determined one or more other datasets, generating the definition of the expanded view dataset that specifies the base dataset, the one or more other datasets and one or more relationships among the base dataset and the one or more other datasets.

10. The method of claim 1, further including:
storing, in a hardware storage device, the definition of the expanded view dataset, and
registering the definition of the expanded view dataset with a data catalog.

11. The method of claim 1, further including:
receiving a request for the expanded view dataset,
responsive to the request, providing the expanded view dataset, by:
retrieving, from a hardware storage device, the definition of the expanded view dataset,
based on the definition of the expanded view dataset, retrieving, from one or more data sources, the base dataset and the one or more other datasets, and
based on data in the retrieved datasets, generating the expanded view dataset.

12. The method of claim 11, further including:
based on the expanded view dataset, determining whether to update a data catalog to specify the definition of the expanded view dataset as a data source,
storing, in a hardware storage device, the definition of the expanded view dataset, and
registering the definition of the expanded view dataset with the data catalog.

13. The method of claim 7, further including:
based on the provided preview of the attributes of the expanded view dataset, determining whether to update the data catalog to specify the definition of the expanded view dataset as a data source.

14. The method of claim 1, wherein generating the available dataset includes:
using the definition of the expanded view dataset to only access those datasets with the specified one or more fields and including data of those accessed datasets into the available dataset.

15. The method of claim 1, further including:
processing the generated available dataset to obtain a result from processing the data of the available dataset.

16. The method of claim 1, further including:
providing a user permission to access portions of the base dataset in the expanded view dataset, while denying the user access to remaining portions of the base dataset.

17. The method of claim 1, wherein the definition of the expanded view dataset comprises a computational graph that specifies a set of data processing operations to generate the expanded view dataset that includes the data from the base dataset and the other datasets related to the base dataset, the set of data processing operations including at least one operation to join the data from the base dataset and data from at least one of the other datasets related to the base dataset.

18. The method of claim 1, wherein the definition of the expanded view dataset provides logical access to data from the base dataset and the other datasets related to the base dataset.

19. A data processing system for enabling a user to preview attributes of fields of an expanded view of a base dataset and to specify one or more of the fields to use in downstream data processing and generating a dataset that includes the one or more of the fields from the preview specified to be used in the downstream data processing, with the generated dataset having increased efficiency with respect to speed and data memory, relative to an efficiency of generating a dataset including all the fields of the expanded view when only the specified one or more of the fields are used in the downstream data processing, including:
one or more processing devices; and
one or more machine-readable hardware storage devices storing instructions that are executable by the one or more processing devices to perform operations including:
receiving an identification of a base dataset,
based on the identification, receiving a definition of an expanded view dataset,
wherein the definition of the expanded view dataset specifies other datasets or fields of other datasets related to the base dataset,
based on the definition of the expanded view dataset, outputting a preview of attributes of fields of the expanded view dataset, wherein the preview is generated from a subset of data in the other datasets or in the fields of the other datasets related to the base dataset,
receiving input that specifies one or more of the fields in the preview to be available for data processing, and
based on the input, generating an available dataset that includes data in the base dataset and data in the one or more of the fields specified.

20. One or more machine-readable hardware storage devices for enabling a user to preview attributes of fields of an expanded view of a base dataset and to specify one or more of the fields to use in downstream data processing and generating a dataset that includes the one or more of the fields from the preview specified to be used in the downstream data processing, with the generated dataset having increased efficiency with respect to speed and data memory, relative to an efficiency of generating a dataset including all the fields of the expanded view when only the specified one or more of the fields are used in the downstream data processing, the one or more machine-readable hardware storage devices storing instructions that are executable by one or more processing devices to perform operations including:
receiving an identification of a base dataset,
based on the identification, receiving a definition of an expanded view dataset,
wherein the definition of the expanded view dataset specifies other datasets or fields of other datasets related to the base dataset,
based on the definition of the expanded view dataset, outputting a preview of attributes of fields of the expanded view dataset, wherein the preview is generated from a subset of data in the other datasets or in the fields of the other datasets related to the base dataset,
receiving input that specifies one or more of the fields in the preview to be available for data processing, and
based on the input, generating an available dataset that includes data in the base dataset and data in the one or more of the fields specified.

21. A method implemented by a data processing system for: enabling a user to preview attributes of fields of an expanded view of a base dataset and to specify one or more of the fields to use in downstream data processing and generating a dataset that includes the one or more of the fields from the preview specified to be used in the downstream data processing, with the generated dataset having increased efficiency with respect to speed and data memory, relative to an efficiency of generating a dataset including all the fields of the expanded view when only the specified one or more of the fields are used in the downstream data processing, including:
receiving an identification of a base dataset,
based on the identification, receiving a definition of an expanded view dataset,
wherein the definition of the expanded view dataset specifies other datasets or fields of other datasets related to the base dataset,
based on the definition of the expanded view dataset, outputting a preview of attributes of fields of the expanded view dataset, wherein the preview is generated from a subset of data in the other datasets or metadata of the other datasets related to the base dataset,
receiving input that specifies one or more of the fields in the preview to be available for data processing, and
based on the input, generating an available dataset that includes data in the base dataset and data in the one or more of the fields specified.

22. The method of claim 21, wherein the preview is generated at development time.
